(19) United States
(12) Patent Application Publication
(10) Pub. No.: US 2016/0213013 A1
(43) Pub. Date: Jul. 28, 2016

(54) Use of Probiotics in Meat

(71) Applicant: NUTRI-QUAL INC., Laval (CA)

(72) Inventor: Pierre TISSERAND, Laval (CA)

(21) Appl. No.: 15/088,601

(22) Filed: Apr. 1, 2016

Related U.S. Application Data
(63) Continuation of application No. PCT/CA2014/050946, filed on Oct. 1, 2014.

(30) Foreign Application Priority Data
Oct. 2, 2013 (CA) 2829344

(51) Int. Cl. A23B 4/22

(52) U.S. Cl. CPC A23B 4/22; A23L 1/31472; A23V 2002/00

(57) ABSTRACT

The present invention relates to the use of probiotics in meat for preserving the meat and for enhancing the consumer's health. A process for reducing proliferation of and/or for killing pathogenic bacteria in meat is disclosed, the process comprising the steps of: providing a raw meat, the raw meat being free of dry or fermented meat; and adding an effective amount of probiotics to the raw meat, the probiotics inducing no acidification or fermentation of the meat. A product of meat having an extended shelf life is also disclosed. The product comprises a raw meat free of dry or fermented meat; and an effective amount of probiotics for reducing proliferation of and/or for killing pathogenic bacteria in the raw meat while inducing no acidification or fermentation of the product. The probiotics present in the product of meat increase the product's shelf-life compared to a product of meat without probiotic.

### CROSS-REFERENCE TO RELATED APPLICATIONS

This application is a continuation of International Application No. PCT/CA2014/050946, with an international filing date of Oct. 1, 2014, now abandoned, which claims the benefits of priority of Canadian Patent Application No. 2,829,344, entitled “Use of probiotics in meat” and filed at the Canadian Intellectual Property Office on Oct. 2, 2013. The entire contents of each of the above identified applications are hereby incorporated by reference in their entirety.

### FIELD OF THE INVENTION

The present invention relates to the use of probiotics in meat. More particularly, the present invention relates to the use of probiotics for preserving the meat and for enhancing the consumer's health.

### BACKGROUND OF THE INVENTION

It is well known in the art that preservation of the meat, once cut from the animal, until eaten by the consumer is a serious issue. The cold chain must not be interrupted, the transport must be fast. Serious hygienic measures are put in place in order to reduce the amount of exogenous microorganisms in contact with the meat. Some methods are known for drying the meat or fermenting the meat (See Luc de Vuyst et al, Probiotics in fermented sausages, in Meat Science, Volume 80, Issue 1, September 2008, p 75-78, Elsevier; Renata Ernlund Freitas de Macedo et al, Probiotic Meat Products, in Probiotic in Animals, Chapter 5, book edited by Everlon Cid Rigobelo, 2012, both incorporated by reference).

However, most of these conventional systems are not provided with an efficient protection and conservation of the meat.

Hence, in light of the aforementioned, there is a need for an improved method of preservation of the meat, which by virtue of the use of probiotics, would be able to overcome some of the above-discussed prior art problems.

### SUMMARY OF THE INVENTION

The object of the present invention is to provide the use of probiotics in meat.

The object of the present invention is to provide the use of probiotics in meat to reduce the proliferation of and/or kill other bacteria, including pathogenic bacteria (coliforms, E. coli, Enterobacteria, Salmonella, Listeria).

The present invention is directed to a process for reducing proliferation of and/or for killing pathogenic bacteria in meat. The process comprises the steps of providing a raw meat, the raw meat being free of dry or fermented meat; and adding an effective amount of probiotics to the raw meat, the probiotics inducing no acidification or fermentation of the meat; whereby, in use, the probiotics added to the raw meat increase the raw meat's shelf-life compared to a meat without probiotics.

The present invention is also directed to a product of meat having an extended shelf life.

The product comprises a raw meat, the raw meat being free of dry or fermented meat; and an effective amount of probiotics for reducing proliferation of and/or for killing pathogenic bacteria in the raw meat while inducing no acidification or fermentation of the product. The probiotics present in the product increasing the product's shelf-life compared to a product of meat without probiotic.

According to yet another aspect of the present invention, there is also provided a use of probiotics in meat to increase the meat or meat products' shelf-life.

According to yet another aspect of the present invention, there is also provided a use of probiotics in meat to enhance the nutritional quality of the meat.

According to yet another aspect of the present invention, there is also provided a use of probiotics in meat to interact with prebiotics.

According to yet another aspect of the present invention, there is also provided a use of prebiotics with the probiotics described therein.

According to yet another aspect of the present invention, there is also provided a use of probiotics in meat to provide a source of vitamin K in the consumer's gut.

According to yet another aspect of the present invention, there is also provided a composition of probiotics and a buffer.

According to yet another aspect of the present invention, there is also provided a composition of probiotics, prebiotics and a buffer.

In accordance with the present invention, the above object is achieved, as will be easily understood, with probiotics and optionally with prebiotics such as the ones described herein.

The objects, advantages and other features of the present invention will become more apparent upon reading of the following non-restrictive description of preferred embodiments thereof, given for the purpose of exemplification only, with reference to the accompanying figures.

### BRIEF DESCRIPTION OF THE FIGURES

FIG. 1 represents a shelf-life experiment for fresh chicken breasts performed for coliform bacteria. ( [symbol] represents the sample without probiotics; [symbol] represents the sample with combination A of probiotics; [symbol] represents the sample with combination B of probiotics).

FIG. 2 represents a shelf-life experiment for fresh chicken breasts performed for E. coli bacteria. ( [symbol] represents the sample without probiotics; [symbol] represents the sample with combination A of probiotics; [symbol] represents the sample with combination B of probiotics).

FIG. 3 represents a shelf-life experiment for fresh chicken breasts performed for Enterobacteria. ( [symbol] represents the sample without probiotics; [symbol] represents the sample with combination A of probiotics; [symbol] represents the sample with combination B of probiotics).

### DESCRIPTION OF THE EMBODIMENTS

### Definitions

Meat includes meat, meat products and meat end products.

Meat includes the flesh of mammalian species (such as cattle, beef, veal, pig, lamb, sheep, goat, pork, rabbit, etc.), fish, seafood (including crustacean, mollusk, etc), poultry (including chicken, turkey, duck, etc), game (birds, deer, moose, caribou, bison, boar, partridge, paintade, etc) and other animals (including ostrich, emu, kangaroo, crocodile, frogs, snails, snakes, etc). Meat includes fresh, raw, sushi, or cooked meat.

Meat products include edible products for animals or humans, such as boneless or boned cuts of meat, offal, trimmings, meat byproducts (skin, mechanically separated meat, bones, etc.).

Meat end products include processed meat products (deli meats, ham, sausage, meat patty, breaded meat products, prepared meals, ready-to-eat products, mechanically separated meat and other processed meat products.

Probiotics are bacteria associated with beneficial effects for humans and animals which are introduced in food. The beneficial effects of food with added live microbes (probiotics) on human or animal health are being increasingly promoted by health professionals. It has been reported that these probiotics can play an important role in immunological, digestive and respiratory functions.

Probiotics are vegetative bacteria or live bacteria, which can also form spores, under stressing conditions (temperature, pH, light, etc). Bacterial spores are dormant life forms which can exist in a dehydrated state indefinitely, until better conditions are available, such as in the gut, and recover their vegetative form. The probiotics of the invention contain about 40-20% vegetative bacteria and about 60-80% spores. In one aspect, they contain 30% vegetative bacteria and 70% spores. Cooking of the meat containing the probiotics of the invention will kill most of the vegetative bacteria, especially if they did not become spores, and will kill about half of the spores. Probiotics and prebiotics are used in an effective amount to deliver the desired result, but low enough to avoid toxic effect for the human or animal. Health Canada orders to use a fixed amount of probiotics of one billion, per eaten portion, such as one billion of live bacteria after the meat is cooked. The effective amount of probiotics to be added to the raw meat is about 3 billion of probiotics per portion in order to keep about 1 billion of probiotics in the cooked portion delivered to and/or eaten by the consumer. The total bacteria may be a mix of different bacteria.

Probiotics are provided in powder (sachets, capsules, tablets, pellets, freeze dried pellets), cream, gel or liquid (in bottles or vials). They can be mixed with various ingredients.

Amongst probiotic strains, probiotic strains that are not pathogenic for animals and/or humans may be used such as Bacilli strains (Bacillus subtilis, Bacillus clausii, Bacillus cereus, Bacillus coagulens, Bacillus Licheniformis, etc. (examples are found in Bacillus Spores as Probiotics and Food Supplements, in Molecular biological methods for Bacillus, Edited by Colin R. Harwood and Simon M. Cutting, 1990, John Wiley & Sons (Chichester, UK) incorporated by reference), Lactobacilli, Clostridia, Bifidobacteria, Enterococci, Streptococci, Escherichia strains.

Prebiotics are non-digestible food ingredients that stimulate the growth and/or activity of bacteria in the digestive system in ways claimed to be beneficial to health. In one embodiment, they are not pathogenic for humans and/or animals. Prebiotics include oligosaccharides or polysaccharides with a chain of 2 to 20 sugar units, such as inulin.

Consumers include animals and humans who eat meat or meat products.

Buffer is water or any other suitable liquid, known and used in the industry. The liquid can be Butterfield's Buffered Phosphate Diluent, or oil. For instance, a composition of probiotic strain and water may be prepared.

The use of probiotics of the invention in meat helps reducing the proliferation of and/or killing other bacteria, including pathogenic bacteria (Coliforms such as E. coli, Enterobacteria such as salmonella) in said meat.

It is quite counterintuitive to add bacteria in the meat: the goal of best industry practices has always been to reduce the bacterial load rather than to augment the bacterial load.

Adding probiotics in meat, such as one billion probiotics per serving of end product, allows saturation of the bacteria already present in the meat. This saturation has an inhibitory effect on the growth and/or life of all bacteria present in the meat.

Adding a large number of probiotic bacteria per food serving quickly saturates the medium. The bacterial population being quite large, a growth inhibition of the pathogenic bacteria is observed.

Bacteria naturally produce antibiotics, to kill competitive bacteria (U.S. Pat. No. 4,931,398 describes the use of a Bacillus Strain to prevent the growth of aflatoxin-producing fungi in cereals and nuts. Bie, Xiaomei et al (Food science and Technology International, 2006, volume 12, (3) 189) describe an antimicrobial substance produced by Bacillus subtilis which is used for the preservation of milk; both incorporated by reference). It allows the probiotic to reduce proliferation and to inhibit the growth of other bacteria, either pathogenic or not.

Probiotic bacterial strains do not alter the meat's taste, smell and/or visual aspect. An organoleptic study was conducted throughout the product's life. No change was observed neither in its odour, taste or visual aspect. In one aspect, consumers were invited to taste both products, they could not make the difference.

It is known to add bacteria or yeasts in bakery or in fermented meat, either to acidify the product or to allow fermentation. However the probiotic strains of the invention do not induce acidification or fermentation.

The probiotics of the invention are preferably not used with dry meat.

Meat is kept at a temperature according to industry practice, preferably between about 0° and about 8° C. and more preferably between about 0° and about 4° C. This prevents bacteria from having an important cellular activity and hence reduces bacterial growth.

Bacterial strains, including probiotic strains are thermosensitive.

In one embodiment, the probiotic strains of the invention are heat-resistant.

In one embodiment, the probiotic strains of the invention are not pathogenic for humans and/or animals.

In one embodiment, the probiotic strain of the invention is Bacillus subtilis R0179 deposited at the Pasteur Institute (France) under No CNCM I-3471 which is a heat-resistant probiotic, approved for use in foods and beverages. It obtained GRAS (Generally Regarded As Safe) status, a designation created by the US Food and Drug Administration. It has the ability to revert to a spore form when under environmental stress (pH, temperature, activity water, salt, antibiotics . . . ) while reverting to the vegetative form once back in appropriate conditions such as those found in the stomach and the gastrointestinal tract. This feature allows this probiotic to be added in meat and also allows for the use of a “source of probiotic” claim for marketing purposes.

The reason why the Bacillus' heat-resistance and spore form are interesting features is that it is stable regardless of its environment, and its protein layer provides an excellent protection from deep-freezing, thawing, salt, pH changes, and especially cooking. For the probiotic claim to be allowed, the bacteria must still be alive when going through the consumer's digestive tract. If the bacteria are destroyed during cooking, they become less useful.

A series of cooking tests were conducted on various meat products to ensure that the probiotic was viable as well as to figure out the initial quantity of probiotic to put onto or into the products. Also, even if the bacteria are sold as spores, about 30% of these are still in a vegetative form (i.e., not in the form of spores). It is a complex process, but it is not because the bacteria are subjected to a temperature stress during their “preparation” that 100% of bacteria will end up in the form of spores.

That is why this parameter needs to be taken into account in the survival rate calculations, because all vegetative bacteria will die. Up to 80° C., the other bacteria are either barely or not affected by the heat. Beyond this temperature, bacterial destruction begins.

When the Bacillus is in its spore form, it does not extend the shelf-life of the product. Given that the spore has a neutral impact on its environment, the bacterium is protected, but it has no cellular activity and does not interact with its surroundings. The bacteria which are in their vegetative state do however interact with their environment and extend the product shelf-life.

Then once the meat is cooked and eaten, the probiotics find better conditions (temperature, pH etc), the spores return to the vegetative form, the spore coat is broken and/or removed and the probiotics are active in the human or animal digestive system. In one embodiment, a non-heat-resistant probiotic strain is used: as it is in its vegetative form, it can inhibit the growth of other bacteria. The way the vegetative bacterium strain is picked depends upon the type of food that needs protecting, as there are many sorts of probiotic bacteria, and each of them have their own specific strains. For example, Bifidobacterium longum R0175 produces an antibiotic which enables it to resist and kill E. coli. This is particularly interesting for beef products, as E. coli 0157H7 is the most dangerous pathogen for this type of products.

Therefore, for each food type, a specific strain of probiotic or a combination of strains of probiotic will be used to minimize food safety risks and to keep the nutritional advantages of probiotics. In one embodiment, a heat-resistant probiotic is used to keep probiotic properties after the meat is cooked thanks to the sporulation of the probiotic, while a non-heat-resistant probiotic and/or the vegetative form of the heat-resistant probiotic is used to reduce the proliferation of and/or kill other bacteria, including pathogenic bacteria (E. coli, listeria, salmonella).

Probiotics may be used with co-ingredients such as dyes, enzymes, vitamins, mineral supplements, anti-oxydants, preservatives, fats, fibers, omega-3 products etc.

Use of the probiotics of the invention can be made through different processes:
They can be blended with the meat;
They can be injected in the meat, or in the brine;
They can be vaporized on the meat or meat's product's surface, optionally with a spray nozzle;
They can be used in a lyophilized form or in fine droplets;
They can be used optionally with spices.

The following examples are provided by way of illustration, and they are not intended to be limiting of the present invention.

### Example 1

### Plaque for Bacterial Count

### 1. Pre-Environmental Control Procedures:

The manipulations are performed in a working area that is sanitized and sterilized with rubbing alcohol. All items used for manipulations must be sterile (knives and meat cutting boards, use of sterile gloves possible, otherwise no physical contact with meat). A burner is turned on, whose flame colour should be blue at its base (more intense heat), allowing heat to spread over a radius of at least 10 cm around which exposed products and equipment (scale, samples, Petrifilm™, pipettes, etc.) are handled.

### a: Storage:

Unopened packages are stored at a T°<8° C. and the closed packages are kept at a T°=4° C., at a relative humidity of 50%.

### b: Preparing a Sample:

For every meat, about 8-15 g of the raw meat sample is prepared. In one aspect, 11 g is prepared.

A concentration of 1 billion probiotics of Bacillus subtilis R0179 per serving of end product diluted in 1 ml of sterile water, or 1 ml of sterile water for control samples is sprayed on the sample.

Since the tested sample weighs 11 g, it is necessary to calculate the correct dilution to perform in order to get the same ratio of probiotics per serving. If the portion weighs 100 g, then x=(1*10⁹*11/100); x=110*10⁶.

The samples are kept refrigerated at T°=4° C. until the date of sampling.

Buffer solutions containing citrate, bisulfite or sulfate thiosulfate, should not be used as they may inhibit probiotic growth.

According to the current method, the pH is adjusted between 6.6 and 7.2; for acid products, 1N NaOH is used; for alkaline products, 1N HCl is used.

### c: Inoculation:

The samples are put in the stomacher for 2 minutes to extract the bacteria.

The plate is put on a flat surface. The top film is lifted. The pipette is held perpendicular to the plate, and 1 ml of sample is placed in the center of the bottom film. The top film is let fallen back on the bottom film. (It must not be scrolled back on). A spreader, ribbed side down, is put on the top film of the inoculum. A slight pressure is applied on the spreader to spread the inoculum over the circular surface. The spreader must not be twisted or slided. The spreader is lifted. It takes at least 1 min while the gel solidifies.

Dilutions can be made in order to get a better reading.

### d: Incubation:

The plates are incubated—transparent side up—in stacks of 20 plates or less. If necessary, the incubator is moistened in order to minimize moisture loss.

AOAC Official Method 990.12: requires incubation at 35° C.±1° C. for 48 h±3 h for the total count.

AOAC Official Method 991.14: requires incubation at 35° C.±1° C. for 48 h±3 h for E. coli and 24 h±3 h for coliforms.

AOAC Official Method 2003.01 required incubation at 35° C.±1° C. for 24 h±3 h for Enterobacteria.

### e: Interpretation:

The total count can be performed on a regular colony counter or with a magnifier with light after 48 hours. They appear as a pink dot.

After 48 h for E. coli and 24 h for coliforms, the count can be performed on a regular colony counter or with a magnifier with light. They appear as blue colonies (for E. coli) or red colonies (for coliforms) with gas bubbles for coliforms.

After 24 h for Enterobacteria, the count can be performed on a regular colony counter or with a magnifier with light. They appear as yellow colonies.

### Example 2

### Shelf-Life Experiment on Raw Meat

Since meat sold to consumers must abide by Health agencies' regulations and not contain a limited number of pathogenic bacteria, 6 shelf-life tests were conducted on beef meat and 6 more on chicken meat with Bacillus subtilis R0179. For each of these tests, 6 samples were prepared, which were tested after 0 day, 1 day, 2 days, 3 days, 4 days and 5 days.

For each sample, 3 types of microbiology tests were conducted:
Total aerobic count
E. coli/coliform count
Enterobacteria count

Regarding the total aerobic count, these values must be read in view of the fact that both the endogenous bacteria and the added probiotics grow in this environment. Since probiotics were inoculated on the sample and since said probiotics then increase in number, the result for the total aerobic count is higher than usual. This is why these results are not used in the table below.

However, in order to check whether the addition of probiotics influences the growth of various specific bacteria, such as Coliforms (e.g. E. Coli), and/or Enterobacteria (e.g. Salmonella), that reduce the shelf-life of the products, the average results were compared through a statistical method: Student's t-test.

The assumption is that, on average, once the shelf-life test is complete, the samples that were inoculated with the probiotics at a concentration of 1 billion per serving show a count equal to that of a product which was not inoculated with probiotics.

TABLE 1
Student's t-test

| | without | with |
|---|---|---|
| | probiotics | probiotics |
| Coliform | | |
| Average | 12231.9512 | 3810.238095 |
| Variance | 911942950 | 68242702.44 |
| Observations | 40 | 41 |
| Weighted Variance | 484884800 | |
| Degree of freedom | 79 | |
| Value of t | 10.7581906 | |
| Critical value of t | | |
| Bilateral for n = 79 and | 1.9905 | |
| alpha = 0.05 | | |
| Conclusion | Discarded | |
| E. coli | | |
| | 1642.43902 | 825.952381 |
| | 73982686.1 | 21999795.3 |
| | 40 | 41 |
| | 47670358.6 | |
| | 79 | |
| Value of t | 3.33308246 | |
| Critical value of t | | |
| bilateral for n = 79 | 1.9905 | |
| and alpha = 0.05 | | |
| Conclusion | Discarded | |
| Enterobacteria | | |
| | 27130 | 12401.6667 |
| | 1415530462 | 440642520 |
| | 40 | 41 |
| | 922068664 | |
| | 79 | |
| Value of t | 13.6721666 | |
| Critical value of t | | |
| bilateral for n = 79 | 1.9905 | |
| and alpha = 0.05 | | |
| Conclusion | Discarded | |

In practice, a high critical value of t (above 2.5) suggests that the difference observed between the value of t and the critical value of t is much greater than the sole variability strictly due to random sampling. In this case, the value of t for all three categories is greater than 1.99 (10.76, 3.33, 13.67), which tends to suggest differences between the bacterial count averages obtained for the various shelf-life tests, those with and those without probiotics inoculations (coliform, E. coli and enterobacteria).

The hypothesis that the difference between the averages is zero must be rejected, meaning that the averages are not identical. In conclusion, the inoculation of probiotics into meat products has reduced the growth of other bacteria (coliform, E. coli and enterobacteria).

### Example 3

### Shelf-Life Experiment for Raw Chicken Breasts

The tests were performed by an independent accredited laboratory, with Bacillus subtilis R0179.

Tests were performed on 3 types of bacteria: coliform bacteria, E. coli and enterobacteria.

The bacterial counts were recorded after 1, 11, 12 and 13 days.

Three types of products were used:
chicken breasts without probiotics ( [symbol] )
chicken breasts with a first combination of probiotics (combination A: Bacillus subtilis R0179) ( [symbol] )
chicken breasts with a second combination of pro biotics (combination B: Bacillus subtilis R0179 and Bifidobacterium longum 0175) ( [symbol] )

An inoculum of 5% of probiotics in weight, comprising water and probiotics, was added to the total weight of chicken breast. It represents three billions of bacteria on a raw product.

The results are shown in Table 2.

TABLE 2

Day (number)

| | | | |
|---|---|---|---|
| D 1 | D 11 | D 12 | D 13 |

| | |
|---|---|
| Bacteria | CFU/g |

Chicken breast (without probiotic)

| | | | | |
|---|---|---|---|---|
| Coliform | 20 | 10 | 70 | 20 |
| E. coli | 20 | 10 | 60 | 20 |
| Enterobacteria | 15 | 5 | 130 | 50 |

Chicken breast with combination A of probiotics

| | | | | |
|---|---|---|---|---|
| Coliform | 80 | 30 | 10 | 10 |
| E. coli | 80 | 30 | 10 | 10 |
| Enterobacteria | 55 | 5 | 70 | 10 |

Chicken breast with combination B of probiotics

| | | | | |
|---|---|---|---|---|
| Coliform | 20 | 10 | 10 | 10 |
| E. coli | 20 | 10 | 10 | 10 |
| Enterobacteria | 35 | 5 | 25 | 20 |

The results are shown in CFU/g (Colony Forming Unit per gram, i.e. the number of bacterial colonies that are present and alive per gram of product).

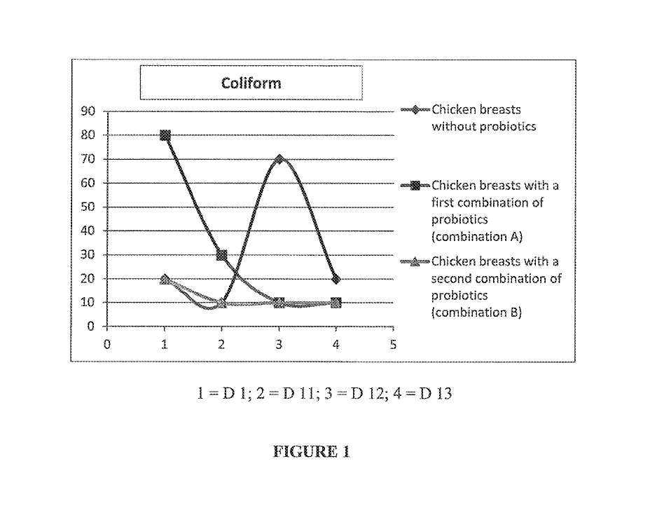

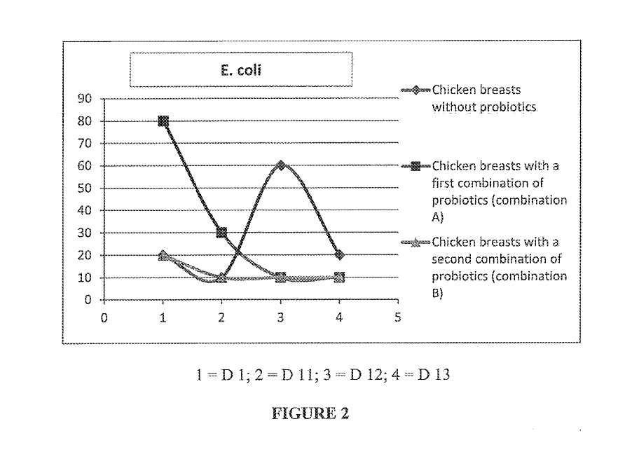

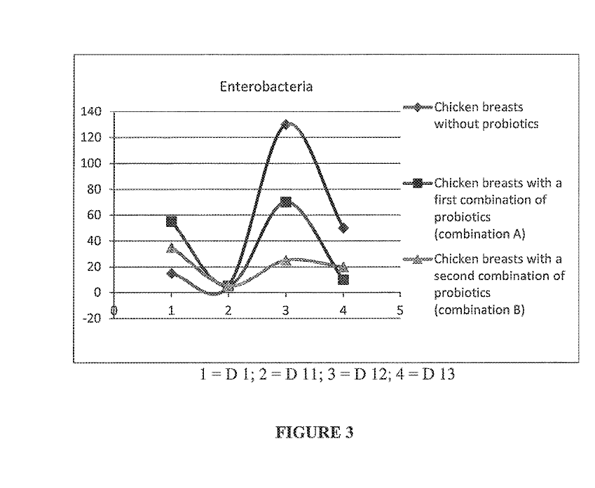

The results are presented in the form of a graph in FIGS. 1-3, with the bacterial population in CFU/g on the vertical axis and the elapsed number of days since testing started on the horizontal axis.

The results shown for each test (e.g. D 11 vs. D 12) may vary due to the fact that each test was performed on a different chicken breast whose initial bacterial populations were different.

As the graphs clearly show, the [symbol] and [symbol] lines, i.e. those depicting chicken breasts with probiotics, indicate a bacterial count close to zero (0) after 13 days.

Table 3 shows the trends for each line:

| | | Breast | |
|---|---|---|---|
| | | (combination | Breast |
| | Breast | A of | (combination B |
| | (no probiotic) | probiotics) | of probiotics) |
| Coliform | 16.527x^{0.4162} | 80.593x^{-1.627} | 17.804x^{-0.508} |
| E. coli | 16.458x^{0.3729} | 80.593x^{-1.627} | 17.804x^{-0.508} |
| Enterobacteria | 8.929x^{1.3656} | 34.792x^{-0.639} | 20.450x^{-0.218} |

For the breast without probiotic, the exponents are positive, which means that the bacterial population is increasing.

On the contrary, when it comes to the two samples with probiotics, the value of the exponents is negative, which indicates that the bacterial population is not increasing, it is decreasing, which means that those bacterial populations are being destroyed.

### Conclusion:

Adding the probiotics of the invention in meat products has prolonged the products' shelf-life. The study shows that the average shelf-life of fresh chicken breasts was extended from 10 to 13 days, which represents a 30% increase of the average shelf-life.

The probiotics also reduced the products' bacterial populations: the number of pathogenic bacterial populations found in the product after 13 days was lower than the initial population count. These results prove the dual role that probiotics play in prolonging a fresh meat product's shelf-life: on one hand, probiotics are a growth inhibitor, which means that they keep the tested pathogenic bacteria from spreading, and on the other hand, probiotics destroy said pathogenic bacteria as the number of bacterial colonies is reduced.

### Example 4

### Shelf-Life Experiment on Ham

The experiment was conducted over 6 weeks.

| | | B. subtilis R0179 | |
|---|---|---|---|
| | Shelf life | Concentration | Survival |
| Sample description | (days) | (cfu/100 g. serving) | rate (%) |
| Ham (with Bacillus R0179 | Inoculation | 3.00E+08 | 100.00 |
| only) | dose (0) | | |
| | 1 week | 5.25E+08 | 174.85 |
| | 4 weeks | 4.96E+08 | 165.48 |
| | 5 weeks | 2.33E+07 | 7.78 |
| | 6 weeks | 1.70E+08 | 56.55 |
| Ham (with Bacillus R0179 | Inoculation | 3.00E+08 | 100.00 |
| and Bifido R0175) | dose (0) | | |
| | 1 week | 4.13E+08 | 137.54 |
| | 4 weeks | 3.32E+08 | 110.79 |
| | 5 weeks | 1.97E+07 | 6.56 |
| | 6 weeks | 2.30E+08 | 76.67 |

The probiotic, Bacillus R0179, survives very well to the process.

Several modifications could be made to the above-described embodiments of the invention, without departing from the scope of the present invention, as can be easily understood by a person skilled in the art.

The scope of the claims should not be limited by the preferred embodiments set forth in the examples but should be given the broadest interpretation consistent with the description as a whole.

What is claimed is:

1. A process for reducing proliferation of and/or for killing pathogenic bacteria in meat, the process comprising the steps of:
providing a raw meat, the raw meat being free of dry or fermented meat; and
adding an effective amount of probiotics to the raw meat, the probiotics inducing no acidification or fermentation of the meat;
whereby, in use, the probiotics added to the raw meat increase the raw meat's shelf-life compared to a meat without probiotics.

2. The process of claim 1, wherein the probiotics in step b) comprises:
a strain of Bacilli, Lactobacilli, Clostridia, Bifidobacteria, Enterococci, Streptococci, Escherichia or a mixture thereof;
a strain of Bacillus subtilis R0179 deposited at the Pasteur Institute in France under No. CNCM I-3471;
a strain of Bifidobacterium longum RO175;
or a mixture thereof.

3. The process of claim 2, wherein the strain of Bacilli comprises Bacillus subtilis, Bacillus clausii, Bacillus cereus, Bacillus coagulens, Bacillus Licheniformis or a mixture thereof.

4. The process of claim 1, wherein the effective amount of probiotics added to the raw meat is about 3 billions of probiotics per portion in order to keep about 1 billion of probiotics in a cooked portion of the meat delivered to and/or eaten by a consumer.

5. The process of claim 1, further comprising the step of adding prebiotics to the meat.

6. The process of claim 5, wherein the prebiotics comprise oligosaccharides or polysaccharides with a chain of 2 to 20 sugar units.

7. The process of claim 6, wherein the prebiotics comprise inulin.

8. The process of claim 1, wherein step b) consists in:
blending the probiotics with the raw meat;
injecting the probiotics in the meat or in a brine thereof; or
vaporizing the probiotics on a surface of the meat, optionally using a spray nozzle; the probiotics being in a lyophilized form or in fine droplets, and being optionally used with spices.

9. The process of claim 1, further comprising the step of keeping the raw meat comprising the probiotics at a temperature of between about 0° C. and about 8° C.

10. A product of meat having an extended shelf life, the product comprising:
a raw meat, the raw meat being free of dry or fermented meat; and
an effective amount of probiotics for reducing proliferation of and/or for killing pathogenic bacteria in the raw meat while inducing no acidification or fermentation of the product,
the probiotics present in the product increasing the product's shelf-life compared to a product of meat without probiotic.

11. The product of claim 10, wherein the probiotics comprises:
a strain of Bacilli, Lactobacilli, Clostridia, Bifidobacteria, Enterococci, Streptococci, Escherichia or a mixture thereof;
a strain of Bacillus subtilis R0179 deposited at the Pasteur Institute in France under No. CNCM I-3471;
a strain of Bifidobacterium longum RO175;
or a mixture thereof.

12. The product of claim 11, wherein the strain of Bacilli comprises Bacillus subtilis, Bacillus clausii, Bacillus cereus, Bacillus coagulens, Bacillus Licheniformis or a mixture thereof.

13. The product of claim 10, wherein the effective amount of probiotics in the product of meat is about 3 billions of probiotics per portion in order to keep about 1 billion of probiotics in a cooked portion of the product of meat delivered to and/or eaten by a consumer.

14. The product of claim 10, further comprising prebiotics.

15. The product of claim 14, wherein the prebiotics comprise oligosaccharides or polysaccharides with a chain of 2 to 20 sugar units.

16. The product of claim 15, wherein the prebiotics comprise inulin.

17. The product of claim 10, further comprising co-ingredients being dyes, enzymes, vitamins, mineral supplements, anti-oxydants, preservatives, fats, fibers, or omega-3 products.
